(19) United States
(12) Patent Application Publication
(10) Pub. No.: US 2006/0038558 A1
(43) Pub. Date: Feb. 23, 2006

(54) Eddy current inspection device

(75) Inventors: Raymond D. Rempt, Woodinville, WA (US); Glenn A. Geithman, Renton, WA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 10/923,519

(22) Filed: Aug. 20, 2004

(51) Int. Cl. G01N 27/72

(52) U.S. Cl. 324/238

(57) ABSTRACT

There is provided an inspection device for the detection of flaws in a component. The inspection device comprises a first linear array of conductors and a second linear array of conductors that is generally parallel and orthogonal to the first linear array of conductors. The electric currents flowing through the first and second arrays create a magnetic field directed into the component that induces unidirectional eddy currents in the component. The unidirectional eddy currents may be rotated through 360 degrees by varying the amplitude and offsetting the phase of the electric currents flowing through the first and second arrays of conductors. When the unidirectional eddy currents encounter a flaw in the component, magnetic field signals in a Z vector are generated. The inspection device comprises a pickup sensor that detects the magnetic field signals to provide an output signal that is processed to determine parameters of the detected flaw.

### BACKGROUND OF THE INVENTION

1. Field of the Invention

The present invention is related to eddy current inspection devices, and more particularly, to inspection devices that induce unidirectional eddy currents of sweepable orientation within the component under inspection.

2. Description of Related Art

Non-destructive evaluation (NDE) of a component to detect flaws within the component may be performed by various techniques that include X-ray radiography, ultrasonics, acoustic emissions, and eddy currents. In particular, eddy current inspection devices are commonly used for NDE of electrically conductive components. Eddy current inspection devices typically use one or more excitation coils to generate an alternating magnetic field, which in turn induces eddy currents in the component, and typically use a pickup coil to detect the magnetic field generated by the eddy currents. When an eddy current encounters an internal flaw of the component, the eddy current flows around the flaw and the resulting magnetic field generated by the eddy current is changed. The pickup coil indirectly detects this change which gives information regarding the location and size of the flaw within the component.

Alternative eddy current inspection devices use a magnetic field generator to induce the eddy currents. U.S. Pat. No. 6,150,809 to Tiernan et al. (“the '809 patent”) uses two parallel sheets of conductors to create the magnetic field and uses a giant magnetoresistive (GMR) sensor positioned between the sheets to detect the magnetic field signals generated by eddy currents. The sheet closer to the component comprises a conductive drive sheet and the sheet further from the component comprises a compensation sheet. Current flows in each sheet to create the magnetic fields. The magnetic field of the compensation sheet is adjusted so that the magnetic fields cancel each other at the position of the GMR sensor so that the GMR sensor detects only the magnetic field signals generated in the component under inspection.

Such an eddy current inspection device that employs parallel sheets of conductors to induce eddy currents may have a limited ability to detect flaws because of the single direction of the eddy currents induced in the component. Because flaws may exist at various orientations relative to the magnetic field and induced eddy currents, the accuracy of an inspection device that induces eddy currents in a single direction is dependent upon the orientation of the flaws or upon the number of times the operator inspects the component at different angular orientations of the inspection device relative to the component.

### BRIEF SUMMARY OF THE INVENTION

The present invention addresses the need for an inspection device that in a single pass provides accurate detection of flaws at various orientations relative to the inspection device. The device provides quick and reliable detection of internal flaws in a component, and advantageously comprises a hand-held device for convenient use. An inspection device of the present invention generates a magnetic field that induces unidirectional eddy currents that have a sweepable, or rotatable, orientation. Because the inspection device induces eddy currents of sweepable orientation, flaws at various orientations relative to the inspection device may be accurately detected in a single inspection pass.

A preferred inspection device includes a magnetic field generator having a first array of conductors disposed in a first plane and a second array of conductors disposed in a second plane that is oriented relative to the first plane such that the second plane is generally parallel and its array of conductors are orthogonal to the first. Currents flowing through the conductors create a magnetic field that induces unidirectional eddy currents within the component under inspection. Advantageously, a current source, which may include processing circuitry, provides currents of variable amplitude, wherein the relative currents fed to the first and second arrays are offset in phase by 90 degrees. The varying amplitude and offset phase allows adjustment of the magnetic field, which induces eddy currents that are directed at any desired angle or that can continuously rotate through 360 degrees. Accordingly, in a single pass, the device can sweep all angles so that a flaw at any orientation relative to the inspection device will generate a magnetic field signal regardless of the physical orientation of the inspection device.

In addition, the inspection device includes a pickup sensor that detects the magnetic field signals generated by eddy currents that encounter a flaw in the component. The pickup sensor may be located on an opposite side of the conductors from the component. Advantageously, the pickup sensor comprises a plurality of anisotropic, or other types of, magnetoresistive sensors. The inspection device may also include a position sensor that moves in concert with the conductors to provide position data of the inspection device during the inspection of the component.

To inspect a component for flaws, the inspection device is positioned on a surface of the component. The inspection device creates a magnetic field that is directed into the component to induce unidirectional eddy currents within the component. The first and second arrays of conductors are each excited by currents of modulated amplitude that are offset in phase by 90 degrees, wherein the variations in the amplitudes of the currents sweep the orientation of the eddy currents. The pickup sensors of the inspection device detect the magnetic field signals generated by the eddy current to determine the location and size of the flaws. Advantageously, the method also includes simultaneously providing position data so that the flaws are accurately located.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of an inspection device illustrating pickup sensors located on an opposite side of the first and second arrays of conductors from the component under inspection; and

FIG. 2 is a descriptive side view of the inspection device of FIG. 1, illustrating the eddy currents induced in the component under inspection and a magnetic field signal generated by the eddy currents encountering a flaw.

### DETAILED DESCRIPTION OF THE INVENTION

One embodiment will be described more fully with reference to the accompanying drawings. The invention may be embodied in many different forms and should not be construed as limited to only the embodiment described and shown. Like numbers refer to like elements throughout.

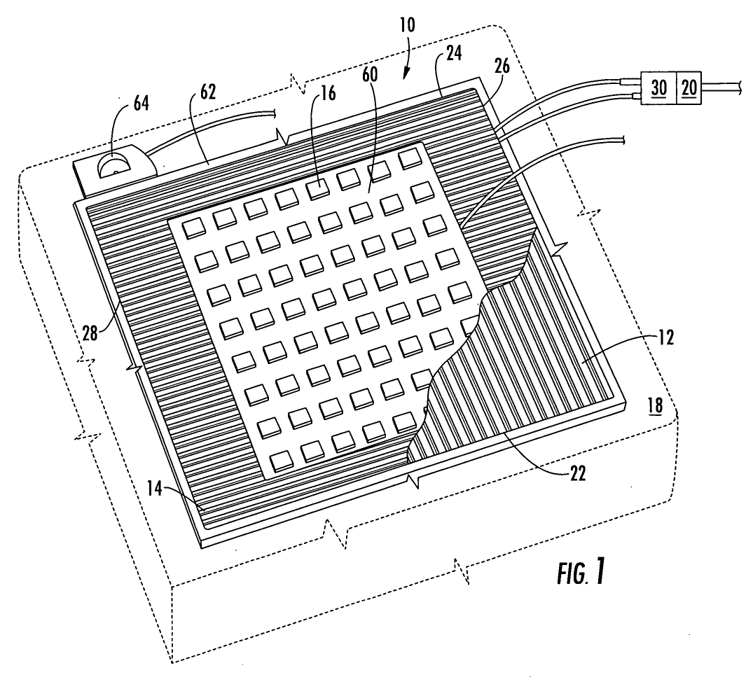

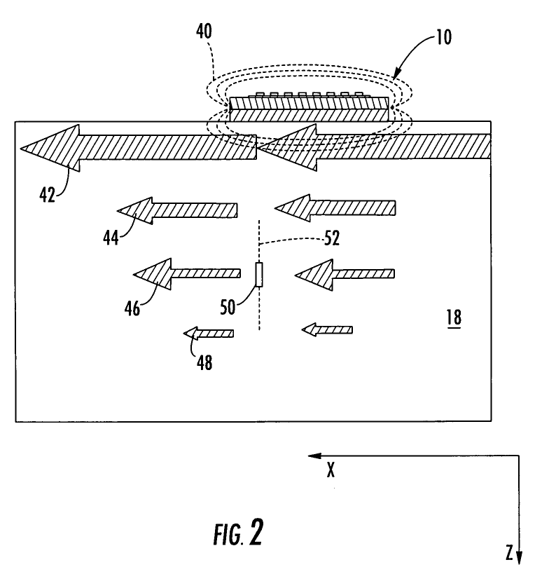

With reference to FIGS. 1-2, an inspection device 10 for the inspection of corrosion in a component, for example, may be used, generally on-location (“in the field”), to inspect any component suitable for eddy current inspection, such as an aircraft wing assembly, to list one non-limiting example. Such a component may include portions that are susceptible and that are not susceptible to induction. The inspection device 10 includes a first linear array of conductors 12, a second linear array of conductors 14, and pickup sensors 16 that are all shown to be packaged in a generally square shape. The first and second arrays 12 and 14 advantageously define a magnetic field generator. Other embodiments have alternative shapes or orient the conductors and sensors in alternative configurations or include additional elements to, for example, facilitate convenient handling of the device or to protect the sensors. For example, the inspection device may include a handle or add electrically insulative material between the sensors to provide protection.

Referring again to FIG. 1, the inspection device 10 is shown positioned on a component 18 under inspection. The first array of conductors 12 of the magnetic field generator is disposed in a first plane and the second array of conductors 14 is disposed in a second plane that is generally parallel to the first array and that is positioned on an opposite side of the first array of conductors from the component, such that the first plane is positioned closer to the component relative to the second plane. Therefore the first and second arrays are stacked in the illustrated embodiment of the present invention. Further embodiments locate the arrays of conductors in alternative positions relative to one another or the component. The first array 12 is oriented relative to the second array 14 such that the first array and the second array are generally parallel and such that the respective conductors extend generally orthogonal to one another. Each array of conductors 12 and 14 of FIG. 1 comprises at least two substantially parallel ribbons of conductive material through which current flows. The individual ribbons of the arrays of conductors 12 and 14 may define lengths, thicknesses, materials, and relative positionings that are suitable for proper generation of the magnetic field and are designed to withstand the heat created as the electric current flows through the ribbons. However, further embodiments of the present invention comprise magnetic field generators of alternative shape or size so long as the magnetic field generated induces a unidirectional eddy current in components under inspection.

The first plane of the first array of conductors 12 and the second plane of the second array of conductors 14 are parallel to one another, such that a perpendicular distance between the two planes is generally constant. However, it is not necessary that the first and second planes be positioned directly above or below one another or that the two planes define an equivalent surface area or thickness. Because the arrays of conductors 12 and 14 each create a magnetic field that emanates in a direction that is generally perpendicular to the first and second planes, respectively, except at the edges of the planes, it is advantageous that the planes are parallel so that the combined magnetic field created by the inspection device emanates in a direction that is generally perpendicular to both the first and second planes to define flux lines within the component that are generally parallel to the first and second planes of the first and second arrays of conductors. Accordingly, the present invention comprises alternative configurations of the inspection device that generate a magnetic field.

The first array of conductors 12 and the second array of conductors 14 are generally oriented orthogonal relative to one another. The inspection device 10 of FIG. 1 comprises a current source 20 for providing a current to the first and second arrays 12 and 14. The current flows from a first lateral edge 22 of the first array 12 to a second lateral edge 24 of the first array such that the direction of current flow is in a generally longitudinal direction. Likewise, the current flows from a first longitudinal edge 26 of the second array 14 to a second longitudinal edge of the second array such that the direction of current flow is in a generally lateral direction. Accordingly, the directions of current flow are generally orthogonal to one another, such that the respective magnetic fields they generate are generally orthogonal to one another. Further embodiments of the present invention have the current flowing in opposite directions relative to the respective edges or orient the first and second planes at different relative angles that are not generally orthogonal, as discussed below.

To generate a single magnetic field for the entire inspection device 10, the current source 20 of the present invention modulates the amplitude of the currents provided to the first and second arrays of conductors 12 and 14 to provide a repeating pattern of amplitude variations. Advantageously, the repeating pattern of amplitude variations steps back and forth between a constant maximum amplitude, such as 100 amps, to list one non-limiting example, and a constant minimum amplitude, such as 0 amps, to list one non-limiting example. The current source 20 of the present invention also is able to offset the phase of the currents provided to the first and second arrays 12 and 14 by 90 degrees, to list one non-limiting example. Advantageously, the current source 20 includes processing circuitry 30 that provides the 90 degree offset; however, further embodiments of the present invention comprise alternative methods for providing the 90 degree offset of phase. One non-limiting example of providing the 90 degree offset without processing circuitry is providing a manual delay device that an operator adjusts to provide the offset.

The inspection device 10 of FIG. 1 offsets the phase of the respective currents by 90 degrees by providing an alternating current flowing through one array of conductors with a frequency and amplitude that are generally equivalent to, yet shifted +/−90 degrees from, the frequency and amplitude of an alternating current flowing through the other array of conductors. For the inspection device 10 of FIG. 1, the amplitude of the current flowing through the first array of conductors 12 is modulated according to a sine wave while the current flowing through the second array of conductors 14 is simultaneously modulated according to a cosine wave, or vice versa, such that the currents are offset by 90 degrees. Further embodiments may offset the currents flowing through the first and second arrays of conductors by alternative methods. Therefore, the alternating currents of each array 12 and 14 provide alternating magnetic fields that are generally orthogonal to one another. However, the 90 degree phase shift in the currents creates a single magnetic field with properties dependent upon the respective amplitudes of the currents flowing through the first and second array 12 and 14. The properties of the magnetic field govern the orientation of the eddy currents induced in the component under inspection. For example, when the amplitude of the current flowing through the first array of conductors 12 is momentarily at the maximum amplitude and the current flowing through the second array of conductors 14 is momentarily at zero amplitude, the orientation of the generated eddy currents is aligned with the first array of conductors in a generally longitudinal direction from the first lateral edge 22 to the second lateral edge 24. Likewise, when the amplitude of the current flowing through the first array 12 is momentarily at zero amplitude and the current flowing through the second array 14 is momentarily at the maximum amplitude, the orientation of the generated eddy currents is aligned with the second array of conductors in a generally lateral direction from the first longitudinal edge 26 to the second longitudinal edge 28. The current source 20 modulates the amplitudes of each current so that the combinations of the relative current amplitudes sweep the orientation of the induced eddy currents through 360 degrees. Advantageously, the current source is adapted to modulate the amplitudes of the currents, such as by sine and cosine wave modulation as described above. Advantageously, the eddy currents induced by the magnetic field generator of the present invention advantageously have a constant intensity throughout the entire 360 degree sweep. The rotational speed of the sweepable eddy currents is generally dependent upon the frequency of the electrical current flowing through the arrays of the magnetic field generator. Further embodiments of the present invention provide alternative methods for generating the magnetic field, inducing the unidirectional eddy currents, modulating or otherwise varying the amplitude of the respective currents, sweeping the orientation of the unidirectional eddy currents, providing a variable intensity of the unidirectional eddy currents (for example, the intensity being varied by the operator based upon the parameters of the component under inspection, such as the type or thickness of material, to list two non-limiting examples), and/or sweeping the unidirectional eddy currents an angular amount that is less than 360 degrees.

In addition, alternative embodiments offset the currents an amount greater than or less than 90 degrees. The illustrated embodiment of the inspection device 10 offsets the respective currents by 90 degrees because the first and second arrays of conductors 12 and 14 are generally orthogonal to one another. For alternative inspection devices of the present invention comprising first and second arrays of conductors that are oriented at angles that are not generally orthogonal, the offset phase and/or relative amplitudes of the currents are changed accordingly to generate a magnetic field that induces eddy currents that sweeps 360 degrees with a constant magnitude at a given distance from the inspection device. Still further embodiments of the present invention generate magnetic fields that induce eddy currents that do not define a constant magnitude as the orientation of the eddy currents is swept.

As shown in FIG. 2, the inspection device 10 generates a magnetic field 40 that is directed into the component 18 to induce eddy currents 42-48 within the component. The magnetic field 40 advantageously has a constant intensity as the orientation of the eddy currents is swept; therefore, the induced eddy currents 42-48 of FIG. 2 have a consistent magnitude as the direction of the eddy current flow is swept. As indicated by the linear arrows 42-48, the eddy currents proximate the inspection device 10 induced by the magnetic field 40 flow generally parallel to the first and second planes of the first and second arrays of conductors 12 and 14. The eddy currents 42-48 flow parallel to the first and second planes because the magnetic field 40, which emanates in a direction that is generally perpendicular to both the first and second planes, defines flux lines that are also generally parallel to the first and second planes of the first and second arrays 12 and 14. Furthermore, the arrows 42-48 represent how the magnitude of eddy currents diminishes as the depth of the component from the inspection device 10 increases. As shown in FIG. 2, the largest arrows 42 represent the eddy currents with the greatest magnitude and the arrows 44 and 46 represent how the magnitude of the eddy current decreases with the depth of the component 18 down to the smallest arrows 48 representing the illustrated eddy currents with the least magnitude.

FIG. 2 also represents a flaw 50 within the component 18. The flaw 50 may be an inclusion, crack, foreign particle, rust, corrosion, or any other defect that changes the electrically conductive properties of the component 18. As known in the art, eddy currents induce a magnetic field as they flow through a component. However, when the eddy currents 42-48, which are generally defined along the x-axis of FIG. 2, encounter a flaw 50, the eddy currents flow around the flaw in a y-axis direction (out of the paper), which according to Ampere's Law generates a magnetic field signal 52 in the z-axis direction. The intensity of the magnetic field signal 52 generated depends not only upon the magnitude of the eddy currents 42-48 that encounter the flaw 50 but also upon the orientation of the eddy currents that encounter the flaw. Because a flaw 50 may have any physical orientation relative to the inspection device 10, eddy currents 42-48 with sweepable orientation advantageously generate magnetic field signals 52 of a greatest relative magnitude when eddy currents of a particular orientation encounter a flaw having a particular physical orientation. Accordingly, the generated magnetic field signal 52 has a greater intensity relative to other magnetic fields signals generated by eddy currents of alternative orientation that encounter the same flaw 50. Therefore, the inspection device 10 of the present invention will generally detect flaws 50 regardless of their physical orientation relative to the inspection device 10 because it ensures that eddy currents will be rotated to an orientation at which the eddy current generates a magnetic field signal 52 with the relatively greatest intensity. The ability to generate and detect the magnetic field signals in the z-axis direction enables the inspection device of the present invention to provide improved information concerning a flaw relative to flaw information provided by prior art inspection devices that do not induce eddy currents along the x- and y-axis directions.

The inspection device 10 of FIG. 1 also includes at least one pickup sensor 16 that detects magnetic field signals 52 generated by eddy currents encountering a flaw 50 in the component 18. The pickup sensors 16 of FIG. 1 advantageously detect the z-axis portion of the magnetic field signal 52 in the orientation illustrated in FIG. 2 to produce an output signal indicative of the location, size, and other parameters of the flaw 50, which may be determined using processing circuitry or alternative devices or methods. The pickup sensors 16 of the inspection device 10 shown in FIG. 1 comprises a plurality of anisotropic, or other types of, magnetoresistive sensors arranged in an 8×8 array. Advantageously, the plurality of anisotropic, or other types of, magnetoresistive sensors are properly oriented to detect the z-axis portion of the magnetic field signal 52. In addition, the inspection device 10 may also include anisotropic, or other types of, magnetoresistive sensors oriented to detect x- and/or y-axis portions of magnetic field signals. Using anisotropic, or other types of, magnetoresistive sensors enables the pickup sensors 16 to directly detect the magnetic field signals 52, which is preferred relative to the indirect detection of prior art eddy current inspection devices that include pickup coils that measure the time derivative of the magnetic field signals. Therefore, the anisotropic, or other types of, magnetoresistive sensors provide improved detection of magnetic field signals. Further embodiments of the present invention include at least one pickup sensor that comprise an alternative number of sensors, an alternative arrangement of sensors, and/or alternative types of sensors so long as the pickup sensors are capable of sufficiently detecting the magnetic field signals generated by eddy currents encountering flaws in the component under inspection. One non-limiting example of pickup sensors is a linear array of 32 giant magnetoresistive sensors.

The pickup sensors 16 of the inspection device 10 of FIG. 1 are mounted to the second plane of the second array of conductors 14 such that the pickup sensors are located on an opposite side of the conductors from the component 18. In addition, the pickup sensors 16 of FIG. 1 are mounted in a plane that is parallel to the first and second planes of the first and second arrays of conductors 12 and 14 and is centered with respect to the first and second arrays. The pickup sensors 16 advantageously are separated from the second plane of the second array 14 by an intermediate substrate 60. The substrate 60 is advantageously formed of a material that is transparent to magnetic fields, such as the magnetic field signal 52. Further embodiments of the inspection device of the present invention may have the pickup sensors mounted to any surface at any location on the inspection device provided the pickup sensors sufficiently detect magnetic field signals generated by eddy currents encountering flaws in the component.

Advantageously, the first and second arrays of conductors 12 and 14 are included within a circuit board 62. The circuit board 62 may provide protective layers along the edges of the first and second arrays 12 and 14 and may provide insulating and/or protective layers above, between, and/or below the first and second arrays of conductors. The current source 20 and processing circuitry 30 may also be mounted to the circuit board 62 in further embodiments of the present invention. Similarly, the processing circuitry that advantageously processes the signals of the pickup sensors 16 may be included in the circuit board 62 in still further embodiments of the present invention. Advantageously, the circuit board 62 is included in the housing that contains the magnetic field generator and the pickup sensors. Furthermore, the housing is advantageously configured for convenient hand-held operation of the inspection device 10. The housing advantageously defines a polymer material for protection of the magnetic field generator, the pickup sensors, and other elements of the present invention, such that the housing does not adversely affect the performance of the inspection device.

The inspection device 10 of FIG. 1 also comprises a position sensor 64 that moves in concert with the first and second arrays of conductors 12 and 14 such that the position sensor provides position data of the inspection device during the inspection of the component 18. The position sensor 64 of the illustrated embodiment is an encoder wheel; however, further embodiments of the present invention may comprise alternative position sensors, such as an optical sensor, to list one non-limiting example. As shown in FIG. 1, the position sensor 64 is advantageously mounted to the circuit board 62 or other structure so that it moves in concert with the first and second array of conductors 12 and 14. The position sensor 64 creates a signal that is advantageously processed, such as by processing circuitry, to provide position data of the inspection device 10 that may be correlated with the signals produced by the pickup sensors 16 to accurately locate flaws that are detected by the pickup sensors. Further embodiments of the present invention may comprise alternative devices or methods for determining the actual location of the flaws detected by the pickup sensors.

The present invention also provides methods for performing an eddy current inspection of a component. To inspect a component 18 for flaws 50 as shown in FIG. 2, the inspection device 10 is positioned on a surface of the component. Advantageously, the housing of the inspection device 10 defines a hand-held embodiment that may be conveniently positioned on the component 18 by an operator in the field and conveniently moved along the component to inspect the desired regions of the component. For example, the component under inspection may be a portion of an aircraft, such as a wing portion, that may be field tested by the hand-held embodiment of the present invention by manually placing the inspection device upon the portion without disassembling the aircraft or other component under inspection. The magnetic field generator of the inspection device 10 generates a magnetic field 40 that is directed into the component to induce unidirectional eddy currents 42-48 within the component. The first and second arrays of conductors 12 and 14 of the magnetic field generator are each excited by currents of modulated amplitude that are offset in phase by 90 degrees. Advantageously, the magnetic field 40 induces unidirectional eddy currents 42-48 that are continuously rotated through 360 degrees as described above. When the eddy currents 42-48 induced by the magnetic field 40 encounter a flaw 50 in the component 18, the eddy currents generate magnetic field signals 52. The pickup sensors 16 of the inspection device 10 detects the magnetic field signals 52 to determine the location and size of the flaws. Advantageously, position data is simultaneously provided by a position sensor 64 that moves in concert with the first and second arrays of conductors 12 and 14 and the pickup sensors 16 so that the flaws 50 are accurately located.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Terms are used in a generic and descriptive sense and should not be used for purposes of limiting the scope of the invention except by reference to the claims and the prior art.

That which is claimed:

1. An inspection device for the detection of flaws in a component under inspection, comprising:
a magnetic field generator to create a magnetic field directed into the component to induce unidirectional eddy currents within the component;
at least one pickup sensor arranged to detect magnetic field signals generated by the eddy currents encountering the flaws in the component; and
a housing containing the magnetic field generator and the pickup sensor.

2. An inspection device according to claim 1 wherein the magnetic field generator contacts the component under inspection, and the pickup sensor is offset from the component.

3. An inspection device according to claim 1, further comprising a position sensor mounted on the housing to move in concert with the housing such that the position sensor provides position data of the inspection device during the inspection of the component.

4. An inspection device according to claim 1 wherein the housing comprises a circuit board that contains the magnetic field generator and the pickup sensor.

5. An inspection device according to claim 1 wherein the magnetic field generator comprises a first array of conductors and a second array of conductors that is generally parallel and orthogonal to the first array of conductors, such that electrical current flowing through the first and second arrays of conductors creates the magnetic field.

6. An inspection device according to claim 5, further comprising a current source for providing currents of variable amplitude to the first and second array of conductors.

7. An inspection device according to claim 6 wherein the current source further comprises processing circuitry for varying the amplitude of the currents.

8. An inspection device according to claim 6 wherein the current source is adapted to vary the amplitude of the currents so as to sweep the orientation of the unidirectional eddy currents through 360 degrees.

9. An inspection device according to claim 8 wherein the current source is adapted to vary the amplitude of the currents so as to continuously rotate the unidirectional eddy currents through 360 degrees.

10. An inspection device according to claim 1 wherein the pickup sensor comprises a plurality of magnetoresistive sensors.

11. An inspection device according to claim 1 wherein the housing is configured for hand-held operation of the inspection device.

12. An inspection device for the detection of flaws in a component under inspection, comprising:
a magnetic field generator having a first array of conductors and a second array of conductors that are generally parallel and orthogonal to the first array of conductors, such that electrical current flowing through the first and second arrays of conductors creates a magnetic field directed into the component to induce unidirectional eddy currents within the component;
at least one pickup sensor having a plurality of magnetoresistive sensors arranged to detect magnetic field signals generated by eddy currents encountering the flaws in the component; and
a housing containing the magnetic field generator and the pickup sensor.

13. An inspection device according to claim 12 wherein the magnetic field generator contacts the component under inspection, and the pickup sensor is offset from the component.

14. An inspection device according to claim 12, further comprising a position sensor mounted on the housing to move in concert with the housing such that the position sensor provides position data of the inspection device during the inspection of the component.

15. An inspection device according to claim 12 wherein the housing comprises a circuit board that contains the magnetic field generator and the pickup sensor.

16. An inspection device according to claim 12, further comprising a current source for providing currents of variable amplitude to the first and second array of conductors.

17. An inspection device according to claim 16 wherein the current source further comprises processing circuitry for varying the amplitude of the currents.

18. An inspection device according to claim 16 wherein the current source is adapted to vary the amplitude of the currents so as to sweep the orientation of the unidirectional eddy currents through 360 degrees.

19. An inspection device according to claim 18 wherein the current source is adapted to vary the amplitude of the currents so as to continuously rotate the unidirectional eddy currents through 360 degrees.

20. An inspection device according to claim 12 wherein the plurality of magnetoresistive sensors comprises a plurality of anisotropic magnetoresistive sensors.

21. An inspection device according to claim 12 wherein the housing is configured for hand-held operation of the inspection device.

22. A method of inspecting a component for flaws, the method comprising the steps of:
positioning an inspection device on a surface of the component, wherein the inspection device comprises a pickup sensor having a plurality of magnetoresistive sensors;
creating a magnetic field directed into the component to induce unidirectional eddy currents within the component so that magnetic field signals are generated by the eddy currents encountering the flaws in the component; and
detecting the magnetic field signals with the pickup sensor.

23. A method according to claim 22, further comprising the step of processing an output from the pickup sensor to define parameters of the detected flaw.

24. A method according to claim 23, further comprising the step of displaying image data derived from the parameters of the detected flaw.

25. A method according to claim 23, further comprising the step of recording the parameters of the detected flaw.

26. A method according to claim 22, further comprising the step of providing position data of the inspection device during the inspection using a position sensor.

27. A method according to claim 22 wherein positioning the inspection device comprises manually positioning a hand-held inspection device on the surface of the component.

28. A method according to claim 27 wherein manually positioning a hand-held inspection device on the surface of the component comprises field-testing the component.

29. A method according to claim 22 wherein creating a magnetic field comprises offsetting relative currents of a first array of conductors and a second array of conductors in phase by 90 degrees, to induce unidirectional eddy currents of sweepable orientation.

30. A method according to claim 29 wherein creating a magnetic field further comprises continuously rotating the unidirectional eddy currents through 360 degrees.
